(19) United States
(12) Patent Application Publication
(10) Pub. No.: US 2018/0173993 A1
(43) Pub. Date: Jun. 21, 2018

(54) System for Identifying a Photographic Camera Model Associated With a JPEG-Compressed Image, and Associated Method Performed in Such a System, Uses and Applications

(71) Applicant: Universite de Technologie de Troyes, Troyes, Cedex (FR)

(72) Inventors: Remi Cogranne, Chamoy (FR); Florent Retraint, Courteranges (FR); Thanh Hai Thai, Troyes, Cedex (FR)

(73) Assignee: Universite de Technologie de Troyes, Troyes, Cedex (FR)

(21) Appl. No.: 15/300,072

(22) PCT Filed: Mar. 27, 2015
(86) PCT No.: PCT/FR15/50807

§ 371 Date: Sep. 28, 2016

(30) Foreign Application Priority Data
Mar. 28, 2014 (FR) 1400768

(51) Int. Cl. G06K 9/52; G06K 9/62

(52) U.S. Cl. CPC G06K 9/522; G06K 9/6271

(57) ABSTRACT

A system and method is described for identifying a photographic camera model from a photograph taking the form of a compressed image that has undergone post-acquisition processing and fulfilling a linear relationship between the expectation and the variance of the pixels, such that σ²y_{m,n}=aμ_{ym,n}+b. The system includes an image processing device that can supply an analytical relationship between parameters (α, β) from the model of the discrete cosine transform (DCT) coefficients and the parameters (a, b) of the camera in the form (I), such that the parameters (c, d) determine fingerprints that characterise a photographic camera model and depend on both the frequency (p, q) and parameters a and b. The system includes a device for carrying out statistical hypothesis tests on the DCT coefficients and a statistical analysis device for determining if the photograph was taken by the photographic camera model or by another photographic camera model.

### 1—TECHNICAL FIELD OF THE INVENTION

The invention pertains to the identification of a photographic camera model, more particularly, the invention relates to a system for determining the identification of a photographic camera model on the basis of a digital photograph having undergone the whole set of processings of the acquisition chain, or indeed compressed according to the JPEG standard. The invention also relates to a method for implementing such a system. These systems find significant applications in determining the provenance of a photograph.

Digital forensics or the search for proofs in a digital medium has undergone significant development over the last decade. In this field, proposed procedures fall into two categories depending on whether one wishes to identify the photographic camera model or the camera itself (an instance of a certain model).

Generally, identification procedures are passive or active. In the case of active procedures, the digital data representing the content of the image are modified so as to insert an identifier (so-called watermarking procedure). When the inspected image does not contain any watermark, the acquisition camera must be identified on the basis of the data of the image.

### 2—PRIOR ART

Two key problems are identified in relation to forensics: identification of the origin of the image and detection of false images (see [1]-[3] and the references incorporated into these documents). Identification of the origin of the image is aimed at verifying whether a given digital image is acquired by a specific photographic camera (i.e. an instance) and/or at determining its model. The detection of false images is aimed at detecting any act of manipulation such as splicing, removal or addition in an image. Two approaches, active and passive, exist for solving these problems. Digital watermarking is considered to be an active approach. There are nonetheless a few limitations cf. [3] since the incorporation mechanism must be available, and the credibility of the information incorporated in the image remains arguable. The passive approach has been increasingly studied in the last decade. The watermark, or the prior information of the image, including the availability of the original image, is not required in its mode of operation. Passive forensics procedures rely on the fingerprints of the photographic camera, left in the image, to identify its origin and verify its authenticity. These prints are extracted by the image acquisition processing chain; see references [4]-[6], for an insight into the various steps and the structure of the various processing within a digital photographic camera.

The passive forensics procedures proposed for the problem of identifying the origin of the image can be divided between the following two fundamental categories. The procedure of the first category is based on the hypothesis that differences exist between the models of cameras, whether in respect of the image processing techniques and in respect of the technological components. Indeed, the aberration of the objective cf. [7], the “Color Filter Array” (CFA), the interpolation algorithm, dematrixing cf. [8]-[11], and JPEG compression see references [12], [13] are considered to be influential factors in identifying the model of the photographic camera when white balancing algorithms [14] are used for identifying the source camera. On the basis of these factors, a set of functionalities is provided and used in the automatic learning algorithm. The main challenge is that the image processing techniques remain identical or similar and, the components, produced by a few manufacturers, are shared between the models of photographic cameras. Moreover, as in all applications of automatic learning, it is difficult to select a set of precise functionalities. Furthermore, the analysis of the deployment of detection performance remains an open problem cf. [15].

The procedure of the second category is aimed at identifying the unique characteristics, or fingerprints, of the acquisition camera. The “Sensor Pattern Noise” (SPN) or characteristic noise of a sensor, is based on the imperfections resulting from the process for manufacturing the photographic sensor and on the non-uniformity during electronic conversion of the photo because of the lack of homogeneity of the silicon wafers (also called “Photo-Response Non-Uniformity” or PRNU). This is a unique fingerprint, see references [17]-[21]. Moreover, the procedures based on the presence of non-uniformity noise (PRNU) are also used in reference [22] for identifying the model of the photographic camera. These procedures are based on the hypothesis that the fingerprint obtained on the basis of an image in the TIFF or JPEG format contains traces of the intrinsic watermark, namely the SPN containing information about the model of the photographic camera.

It should be noted that the two main components of the Sensor Pattern Noise SPN are the “Fixed Noise Pattern” (FPN) and the “Photo-Response Non-Uniformity” PRNU. The FPN, or “fixed shape noise structure”, which is used in reference [23] for identifying the camera, is generally compensated for in a photographic camera by subtracting a dark image on the output image. Consequently, the Fixed Noise Pattern (FPN) is not a robust fingerprint and will not be able to be used in subsequent works. The PRNU is utilized directly in certain works, see references [17], [18], [21]. The ability to reliably extract this noise from the image is the main challenge in this category. Another challenge is the falsification of the origin of the image due to “counter-analysis” activities, see reference [24]. However, the existing procedures are designed with very limited utilization of the theory of hypothesis testing and statistical image models. Consequently, their performance is not yet analytically established.

Most legal medicine image procedures rely on the noise of the sensors, see references [22], [25], or on characteristics geared toward operations in the photographic camera, see reference [10]. Most digital photo cameras export images in the JPEG format. The ability to extract image characteristics is placed in doubt because the JPEG compression may seriously damage these characteristics. In the patent application referenced as [25] we have proposed to utilize the parameters (a, b) to passively identify a photographic camera model. This procedure is based on the heteroscedasticity of the noise present in a RAW image. A RAW image is an image that has not undergone any of the post-acquisition processing of the processing chain). The patent application referenced as [25] shows perfect detection performance for the identification of a photographic camera model on the basis of the RAW images, of uncompressed images or of lossless compressed images. However, it is useful to extend this procedure to TIFF or JPEG format compressed images.

The issue tackled in the present invention is that of the passive identification of an acquisition photographic camera model on the basis of a given compressed image. Passive identification is understood to mean taking a decision in the case where the image is not assumed to contain any information identifying the source. The problems that it is envisaged to solve are 1) to ensure that a photograph has not been taken by a given camera when the photograph is compromising or, 2) conversely, to guarantee that an inspected photograph has indeed been taken by one camera rather than by another. The examples that may be given are numerous, including: this photographic camera is responsible for the photograph of the confidential document (such as those available on wikileaks); could a given photograph of a pedopornographic nature have been acquired with the photographic camera of a suspect; has the copy of a contract been scanned with the client's camera; the photograph of a document makes it possible to copy and mark the document etc.

### 3—DISCLOSURE OF THE INVENTION

The aim of the invention is to provide a system for identifying a photographic camera model on the basis of images acquired with a known photographic camera model and of a photograph in the form of a compressed image, said photograph having undergone a post-acquisition processing and obeying the linear relation between the expectation and the variance of the pixels such that: σ²_{ym,n}=a μ_{ym,n}+b where a and b are two parameters characterizing said photographic camera model, μ_{ym,n} and σ²_{ym,n} are respectively, the expectation and the mathematical variance of the pixel y_{m,n} at the position (m,n) having undergone the post-acquisition processing, the system is characterized in that it comprises an image processing device able to provide an analytical relation between parameters (α, β), of the statistical distribution model of the DCT, Discrete Cosine Transformation, coefficients and the parameters (a, b) of the photographic camera in the form: β_{p,q}⁻¹=c_{p,q}α_{p,q}+d_{p,q} so that the parameters (c, d) determine fingerprints characterizing a photographic camera model and depend both on the frequency (p, q) and on the parameters a and b, in that the system furthermore comprises a device for executing statistical hypothesis tests of the DCT coefficient and a statistical analysis device so as to determine whether said photograph has been taken by said photographic camera model or by another photographic camera model. Basically the images for which the acquisition model is known constitute the source of the identification of the photographic camera model.

Advantageously, the analysis device provides an indication about the identification of said photographic camera model by certifying the accuracy of the identification with a previously defined precision.

The invention further relates to a method implemented in said system, which comprises the following steps:
prior analysis of images acquired with a known photographic camera model,
reading of a compressed image Z with a view to determining the matrices representing the value of the pixels,
estimation of the parameters of prints: (c_{p,q}, d_{p,q}),
   deletion of the content of the compressed image Z so as to obtain a residual image,
   estimation of the DCT coefficients of said residual image,
execution of comparative statistical tests with a view to identifying a photographic camera.
   A prior analysis of images acquired with a known photographic camera model is carried out with a view to estimating print parameters (c_{p,q}, d_{p,q}), according to the same method as for the analysis of an unknown image.

Advantageously, the statistical tests are executed as a function of a prescribed constraint on the probability of error.

According to the invention, the photograph is a compressed image, according to the JPEG compression standard.

Advantageously, the photograph is a reference, or inter-frame, image belonging to a video stream, and compressed according to the MPEG compression standard.

The invention further relates to the use of the method hereinabove for the detection in an unsupervised manner of the falsification of a zone of a photograph.

Moreover, the invention relates to the use of the method hereinabove for the detection, in a supervised manner, of the falsification of a zone of a photograph. This detection is carried out by testing whether an a priori known zone originates from the same photographic camera as the remainder of the inspected image.

The invention further relates to the use of the method hereinabove in the search for proofs on the basis of a compromising image.

The invention relates to the application of the method hereinabove in specialized software, in the search for proofs on the basis of digital media.

### 4—BRIEF DESCRIPTION OF THE FIGURES

Other characteristics, details and advantages of the invention will emerge on reading the description which follows, with reference to the appended figures, which illustrate:

FIG. 1 shows a system for determining the identification of a photographic camera model in accordance with the invention;

FIG. 2 illustrates the whole of the chain for acquiring a natural image and the processings performed in the digital photo cameras;

FIG. 3 shows the comparison between the exact DCT coefficient model equation (7) and the approximation DCT coefficient model equation (8);

FIG. 4 shows the parameters (̂α₆₄, ̂β₆₄) estimated on the basis of each image of the Dresden image database captured with two distinct photo camera models: Canon Ixus 70 and Nikon D200;

FIG. 5 shows the parameters (c₆₄, ̂d₆₄) estimated on the basis of each image of the Dresden image database captured with two distinct photo camera models: Canon Ixus 70 and Nikon D200;

FIG. 6 shows the detection performance of the test δ* for the data simulated with parameters α=3, c0=11.5, d0=−4, c1=13, d1=−5.5;

FIG. 7 shows the detection performance of the tests ̂δ*₁ and ̂δ*₂ for the data simulated with parameters α=3, c0=11.5, d0=−4, c1=13, d1=−5.5;

FIG. 8 shows the detection performance of the tests δ for 500 images arising from the Dresden image database and obtained by two photographic cameras Canon Ixus 70 and Nikon D200.

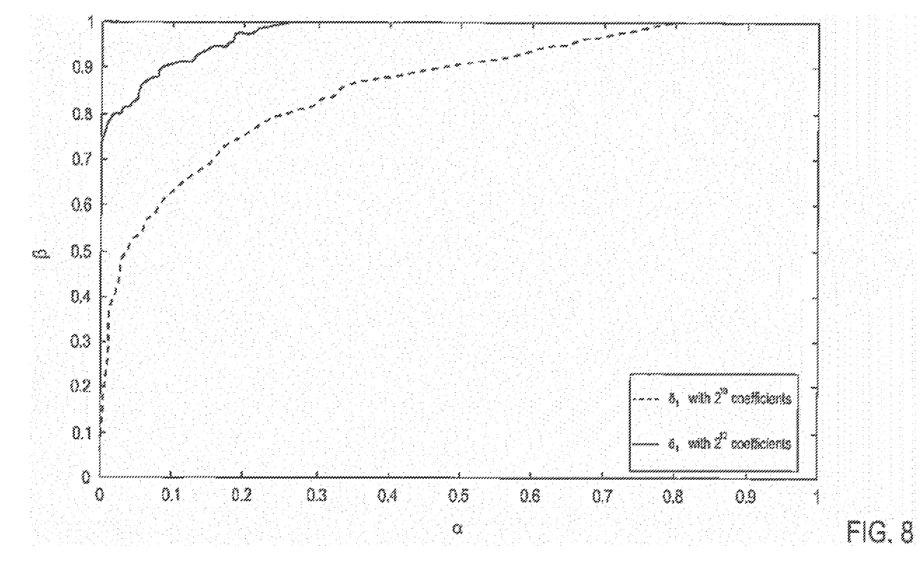

For greater clarity, identical or similar elements are tagged by identical reference signs in all the figures.

### 5—DETAILED DESCRIPTION OF AN EMBODIMENT

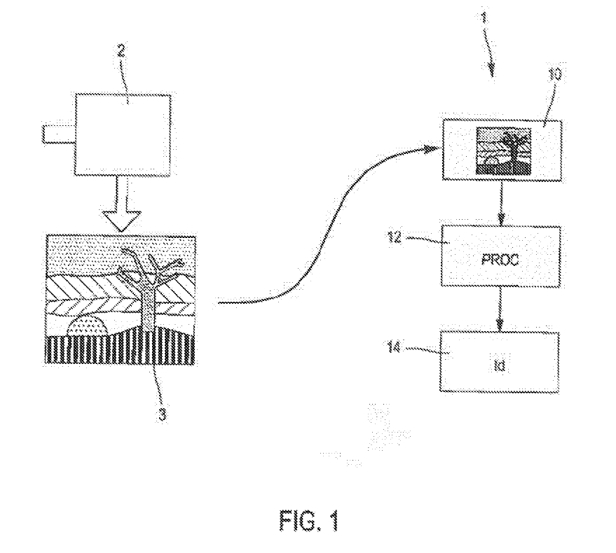

FIG. 1 represents a system for determining the identification of a photographic camera. The reference 1 indicates the system and the reference 2 the model of photographic camera which has taken a photograph 3.

It is on the basis of this photograph 3 that the system 1 will determine the photographic camera model that captured this photograph. This system is composed of a photo analyzer which will examine this photograph 3. The photograph 3 takes the form of a compressed file suitable for the processing which will follow. The formats of JPEG type or any image arising from the decompression of a previously compressed image in the JPEG format, compressed according to the JPEG standard, is suitable for this processing.

The system 1 can be implemented on a computer of PC type. This system 1 is furnished with an input facility 10 so as to be able to enter the data of the photograph 3. These data are processed by a processing facility 12 which implements a processing which will be explained hereinbelow. A device for executing statistical hypothesis tests on the DCT coefficients and a statistical analysis device 14 will provide an indication about the identification of the photographic camera model responsible for said photograph.

According to the method in accordance with the invention, in the first step, the digital photograph 2 is viewed as one or more matrices whose elements represent the value of each of the pixels. In the case of a gray level image, the photograph can be represented by a single matrix:

Z=zᵢ with 1≤i≤L

For color images, three distinct colors are usually used: red, green and blue. In this case, an image may be regarded as 3 distinct matrices, one matrix per color channel:

Z=zᵢ^{k} with 1≤k≤3

The second step of the method consists in separating the various color channels, when the analyzed image is in color. The series of operations being carried out in an identical manner with each of the matrices representing the color channels, we consider that the image is represented by a single matrix (the index k is omitted).

Noise present in digital photographs exhibits the property of being heteroscedastic: The (random) stochastic properties of noise are not constant over the whole set of pixels of the image.

Because of the large number of photons incident on the sensors, it is possible to approximate with high precision the process of counting by a Gaussian random variable.

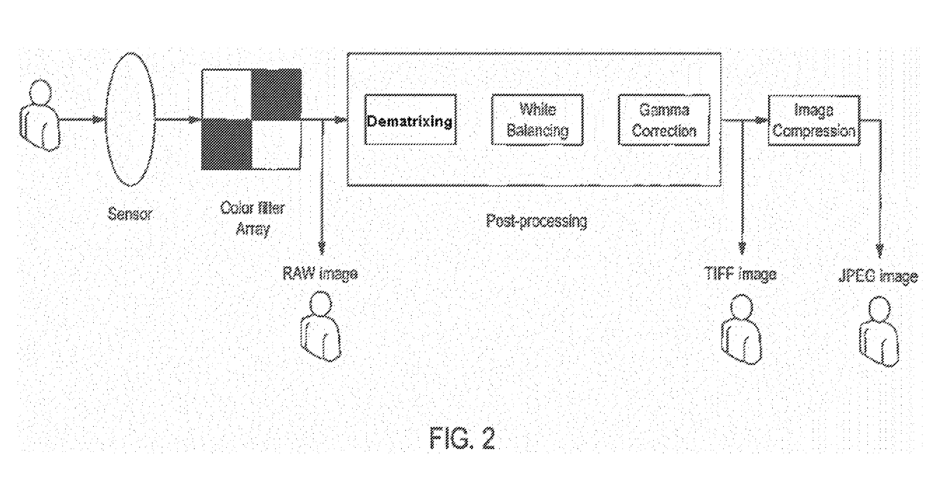

FIG. 2 illustrates the whole of the chain for acquiring a natural image and the processings performed. This acquisition chain comprises several processing steps (dematrixing, white balancing, and gamma correction) subsequent to which a polychromatic image is obtained on the basis of the luminous intensity measured by each photosensitive cell of the sensor. According to the procedure of each step, the quality of the final image can vary appreciably. Each step affects the final output image. It should be noted that the sequence of operations differs from one manufacturer to another.

Today, the JPEG image format is ever more apparent as a standard in digital images. Most digital photo cameras and software code images in this format. The use of JPEG compression is a question of balance between the storage size and the quality of the image. An image which is compressed with a high compression factor requires little storage space to the detriment of lesser visual quality.

The Discrete Cosine Transformation (DCT) operation is one of the key steps of JPEG compression. Given an arbitrary image Z, the DCT operation is applied to each block of 8×8 pixels of Z as follows

$${I}_{p , q} = \frac{1}{4} {T}_{p} {T}_{q} {\sum }_{m = 0}^{7} {\sum }_{n = 0}^{7} {z}_{m , n} \times cos ( \frac{( 2 m + 1 ) p π}{16} ) cos ( \frac{( 2 n + 1 ) q π}{16} ) \qquad ( 1 )$$

where z_{m,n} represents a pixel inside a 8×8 block of Z, 0≤m≤7, 0≤n≤7 and I_{p,q} designates the two-dimensional DCT coefficient and

$${T}_{p} = \{ \begin{matrix}\frac{1}{\sqrt{2}} & for p = 0 \\ 1 & for p > 0\end{matrix} \qquad ( 2 )$$

The term Tq can be easily derived by analogy with the term Tp. The DCT coefficient at the position (0, 0), called the direct current (DC) coefficient, represents the mean value of the pixels in the block of 8×8 pixels. The remaining 63 coefficients are called the alternating current (AC) coefficient. Two main advantages of the DCT operation are sub-optimal decorrelation and energy compacting. After the DCT operation, the energy is situated mainly in the low frequencies while the high frequencies mainly contain components of the noise.

The modeling of the distributions of the DCT coefficients has been widely studied in the literature. The Laplacian model in reference [27], generalized Gaussian model (cf. [28]) and generalized Gamma (GI⁻) model (cf. [29]) have been proposed for the DC coefficients. But the Laplacian distribution remains a dominant choice in image processing because of its simplicity and its relative precision. In our earlier works, we established a rigorous mathematical framework to model the AC coefficients, see more details in reference [6]. As the DC coefficient represents the mean value of the pixels in each block of 8×8 pixels, the DC coefficient distribution cannot be derived directly from the fact of the heterogeneity in a natural image. Let I be an AC coefficient, for the sake of clarity, the index of said AC coefficient is omitted. Because of the variability of the variance of the block, the probability density function (pdf) of the I is given as a function of a bi-stochastic model (cf. [27]) in the following manner

ƒ_{I}(x)=∫₀^{∞}ƒ_{I|σ}_{²}(x|t)ƒ_{σ}_{²}(t)dt, x∈ [symbol] (3)

where f_{X}(x) designates the probability density function (pdf) of a random variable denoted X and where σ² designates the variance of the block considered. It is assumed that the pixels inside a block are independently and identically distributed, cf. [27]. Given σ² a constant variance of the block, the distribution of the AC coefficients of I can be approximated by a Gaussian distribution of zero mean, by virtue of Lindeberg's central limit theorem (CLT) for correlated random variables cf. [27], [30]

$${f}_{I \vert {σ}^{2}} ( x \vert t ) = \frac{1}{\sqrt{2 π t}} exp ( - \frac{{x}^{2}}{2 t} ) \qquad ( 4 )$$

Furthermore, the distribution of the variance σ2 over the whole set of blocks constituting an image may be modeled in an approximate manner by the gamma distribution law G (α, β) cf. [6] defined by the following probability density function (pdf):

$${f}_{{σ}^{2}} ( t ) = \frac{{t}^{α - 1}}{{β}^{α} Γ ( α )} exp ( - \frac{t}{β} ) \qquad ( 5 )$$

where α is a positive shape parameter, β is a positive scale parameter, and σ(⋅) represents the gamma function. On the basis of (3), (4) and (5), the statistical distribution model for the AC coefficient of I is given as:

$${f}_{I} ( x ) = \frac{1}{\sqrt{2 π} {β}^{α} Γ ( α )} {\int }_{0}^{∞} exp ( - \frac{t}{β} - \frac{{x}^{2}}{2 t} ) {t}^{α - \frac{3}{2}} dt \qquad ( 6 )$$

On the basis of [31] and by using the integral representation of the modified Bessel function, denoted Kν(⋅), the integral (6) can be written

$${f}_{I} ( x ) = \sqrt{\frac{2}{π}} \frac{{( \vert x \vert \sqrt{\frac{β}{2}} )}^{α - \frac{1}{2}}}{{β}^{α} Γ ( α )} {K}_{α - \frac{1}{2}} ( \vert x \vert \sqrt{\frac{2}{β}} ) \qquad ( 7 )$$

where Kν(x) represents the modified Bessel function [31, chapter 5.5]. The model of AC coefficients proposed in (7) comprises the particular cases of Laplacian distribution and Gaussian distribution (cf. [6]). As indicated in [6], this model surpasses the Laplace and Gauss models, but to the detriment of more complex expressions. By using the Laplace approximation [32] (see more details in Annex A), an approximation of the function f_{I}(x) can be given as:

$${f}_{I} ( x ) \approx \frac{{\vert x \vert}^{α - 1}}{{( 2 β )}^{\frac{α}{2}} Γ ( α )} {e}^{- \vert x \vert \sqrt{\frac{2}{β}}} \qquad ( 8 )$$

It should be noted that other polynomial expansions of the modified Bessel function Kν(x) are also given in [31], also a polynomial approximation of f_{I}(x) can be derived. However, these approximations are not considered in the present patent application. The precision of the approximation given in (8) depends on the choice of the functions g (t) and h (t) (see further on in relation (56)). The main advantage of relation (8) is to provide an approximation in the form of an exponential function. This approximate model is used to simplify the calculation of the likelihood functions as well as the calculation of the threshold for the likelihood ratio used in the proposed tests. The estimation of the parameters is performed based on the exact model defined in relation (7).

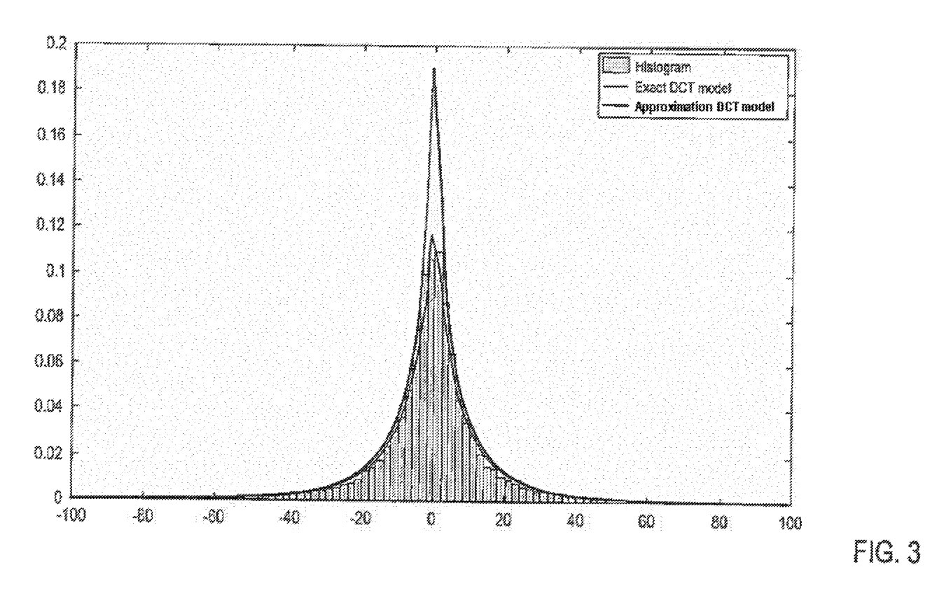

It may be noted that this approximate model is a particular case of the generalized gamma distribution model when γ=1 (the variable γ is given in reference [29, Eq (6).]). An example is given in FIG. 3 to illustrate the precision of the exact model of the distribution of the DCT coefficients of a JPEG image and the precision of the approximate model of the distribution of the DCT coefficients.

The empirical data are extracted on the basis of a real image of the Dresden image database (see [33]) previously compressed using the JPEG compression standard. The parameters are estimated on the basis of the empirical data on the basis of the exact model of the distribution of the DCT coefficients. The exact and approximate models of the DCT coefficient are represented with the parameters estimated by maximum likelihood. The main drawback of the approximation model is that when x tends to 0, the function (8) tends to 0 when α>1, and it tends to infinity when α<1. This leads to an inaccuracy in the neighborhood of 0, as represented in FIG. 3. Nonetheless, this does not cause any loss in detection performance, when the LRT test is designed, as much in terms of capacity to guarantee a false-alarm probability as in terms of probability of correct detection. Since the AC coefficients model defined by relation (7) is symmetric, the odd moments disappear. On the basis of the law for the total expectation, the calculation shows that

[symbol]

_{I}[I²]= [symbol] _{σ}_{²}[ [symbol] _{I|σ}_{²}[I²|σ²]]= [symbol] _{σ}_{²}[σ²]=αβ (9)

[symbol]

_{I}[I⁴]= [symbol] _{σ}_{²}[3σ⁴]=3αβ²(α+1) (10)

where [symbol] ₓ designates the mathematical expectation of a random variable X. Consequently, the method of moments (MM) allows the estimation of the parameters (α, β) as follows:

$$\begin{matrix}{\hat{α}}^{MM} = \frac{{\hat{m}}_{2}}{{\hat{β}}^{MM}} & ( 11 ) \\ {\hat{β}}^{MM} = \frac{{\hat{m}}_{4}}{3 {\hat{m}}_{2}} - {\hat{m}}_{2} & ( 12 )\end{matrix}$$

where ̂m2 and ̂m4 are respectively the second and the fourth empirical moments of I. The estimation of the maximum likelihood (ML) of the parameters (α, β) are defined as the solution of the maximization problem

$$( {\hat{α}}^{ML} , {\hat{β}}^{ML} ) = {arg max}_{( α , β )} {\sum }_{i = 1}^{N} log {f}_{I} ( {I}_{i} ) \qquad ( 13 )$$

where N is the number of coefficients at the same frequency. It should be noted that the likelihood function is differentiable but the calculation of the derivative seems to be extremely difficult. As there is no exact or analytical form for the maximum likelihood (13), it is proposed to solve the maximization problem numerically with the aid of the optimization procedure of Nelder-Mead [34]. The estimations MM (̂α^{MM}, ̂β^{MM}) are taken as initial solution in the optimization algorithm.

As discussed hereinabove, one of the main advantages of the approximation in (8) is the compacting of the energy. The energy has a tendency to be situated mainly in the low frequencies while the high frequencies mainly contain components of the noise. Consequently, there exists a difference of scale between the DCT coefficients. The DCT coefficients do not share the same parameters (α, β). As the estimation of the parameters (α, β) is performed separately on each frequency, we must designate the parameters (α_{p,q}, β_{p q})) with respect to the DCT coefficient of

I_{p,q}.

5.A The Intrinsic Prints of the Photographic Camera

In our earlier works references: [25] and [35], the parameters (a,b) were utilized to passively identify a photographic camera model, where a and b represent parameters characteristic of a photographic camera. This procedure is based on the heteroscedasticity of the noise present in a RAW image. The (random) stochastic properties of noise are not constant over the whole set of pixels of the image. More precisely, the value of each pixel depends linearly on the number of incident photons. This model, which represents all the noise contaminating the RAW image, gives the variance of the noise as a linear function of the mathematical expectation of the pixels and obeys the following relation:

y_{m,n}˜ [symbol] (μ_{y}_{_{m,n}},a↑_{y}_{_{m,n}}+b) (14)

where [symbol] _{m,n} is the measured value of the RAW pixel at the position (m,n) and ^{μ} [symbol] _{m,n} its mathematical expectation. Even though this procedure shows an almost perfect detection performance, there are two main limitations. Firstly, it concentrates on the RAW images, which may not be available in practice. Indeed, the most difficult part when extending this procedure to other image formats, for example TIFF and JPEG, is the impact of the post-acquisition method (dematrixing, white balancing and gamma correction) as well as of the compression method, since the dematrixing causes spatial correlation between the pixels and the non-linear operations destroy the linear relation between the expectation and the variance of the pixel. Secondly, the proposed fingerprint, defined by the parameters (a, b), depends on the ISO sensitivity. Although this is not crucial in practice, since there is not much ISO sensitivity and just a small number of images is sufficient to estimate the reference parameters (a, b) for each ISO sensitivity, it is desirable to count on a print which is invariant with respect to the content of the image and which is robust for the nonlinear transformation operations (for example the gamma correction factor).

To render a color image complete on output and improve its visual quality, a RAW image requires a post-acquisition process, for example, dematrixing, white balancing, and gamma correction. To extend the method referenced in [21] to compressed images, let us assume that the effect of the algorithm for dematrixing and white balancing is negligible on the heteroscedastic relation of the expectation and of the variance of the pixel. Then the compressed image obeys the relation between the expectation and the variance of the pixels such that: σ²_{ym,n}=a μ_{ym,n}+b where a and b are two parameters characterizing a photographic camera model, μ_{ym,n} and σ² [symbol] _{m,n} are respectively the expectation and the mathematical variance of the pixel y_{m,n} at the position m,n.

We shall provide an analytical relation between the parameters (α, β) of the model of the DCT (discrete cosine transform) coefficient and the parameters of the photographic camera (a, b). It is assumed that the pixels in each 8×8 block are independent and identically distributed. Moreover, we assume that the effect of the dematrixing and white balancing algorithm is negligible on the heteroscedastic relation of the expectation and of the variance of the pixel. The gamma correction is defined by the transformation, applied to each pixel independently, defined as follows:

$${z}_{m , n} = {\vert {y}_{m , n} \vert}^{\frac{1}{γ}} = {\vert {μ}_{{y}_{m , n}} + {η}_{m , n} \vert}^{\frac{1}{γ}} = {\vert {μ}_{{y}_{m , n}} ( 1 + \frac{{η}_{m , n}}{{μ}_{{y}_{m , n}}} ) \vert}^{\frac{1}{γ}} \qquad ( 15 )$$

where |⋅| designates the absolute value and y is the correction factor (typically, γ=2.2). Here, [symbol] _{m,n} is referenced as the balanced white pixel and η_{m,n} is a zero-mean signal, representing the pixel noise at the position (m,n) with variance: σ²η_{m,n}=Var [η_{m,n}]= [symbol] [symbol] +b. The first order of the Taylor series expansion of (1+x)^{1/γ} for x=0 leads to:

$${z}_{m , n} = {μ}_{{y}_{m , n}}^{\frac{1}{γ}} + \frac{1}{γ} {μ}_{{y}_{m , n}}^{\frac{1}{γ} - 1} {η}_{m , n} + o ( \frac{{η}_{m , n}}{{μ}_{{y}_{m , n}}} ) \qquad ( 16 )$$

Taking the expectation and the variance on both sides of equation (16), we will obtain:

$${σ}_{{z}_{m , n}}^{2} = \frac{1}{{γ}^{2}} {μ}_{{z}_{m , n}}^{2 - 2 γ} {σ}_{{η}_{{y}_{m , n}}}^{2} - \frac{1}{{γ}^{2}} {μ}_{{z}_{m , n}}^{2 - 2 γ} ( a {μ}_{{z}_{m , n}}^{γ} + b ) \qquad ( 17 )$$

where ^{μz}_{m,n} and σ²z_{m, n} represent, respectively, the value of the expectation and of the variance of the pixel z_{m, n}. Relation (17) is justified under the hypothesis of η_{m,n}<<^{μ}y_{m, n}. Moreover, it may be noted that the variance of the corrected gamma pixel, σ²z_{m, n} is directly proportional to the variance of the noise σ²η_{m,n} and inversely proportional to the value of the expectation ^{μ}z_{m,n}. By taking the variance on both sides of equation (1), it follows that Var [I_{p, q}]=Var [z_{m, n}]=σ²z_{m, n}. This is justified under the hypothesis that the pixels are independent and identically distributed in the 8×8 block. It follows from equation (9) that

$${α}_{p , q} {β}_{p , q} = 𝔼 [ {I}_{p , q}^{2} ] = Var [ {I}_{p , q} ] = \frac{1}{{γ}^{2}} {μ}_{{z}_{m , n}}^{2 - 2 γ} ( a {μ}_{{z}_{m , n}}^{γ} + b ) \qquad ( 18 )$$

Furthermore, from (9) and (10), we obtain

Var[I_{p,q}²]= [symbol] [I_{p,q}⁴]− [symbol] ²[I_{p,q}²]=2α_{p,q}²β_{p,q}²+3α_{p,q}β_{p,q}². (19)

Moreover, a calculation on the basis of (1) yields

$$\begin{matrix}Var [ {I}_{p , q}^{2} ] = {S}_{p , q} Var [ {z}_{m , n}^{2} ] + ( 1 - {S}_{p , q} ) {Var}^{2} [ {z}_{m , n} ] where & ( 20 ) \\ {S}_{p , q} = \frac{1}{{4}^{4}} {T}_{p}^{4} {T}_{q}^{4} {\sum }_{m = 0}^{7} {\sum }_{n = 0}^{7} {cos}^{4} ( \frac{( 2 m + 1 ) p π}{16} ) {cos}^{4} ( \frac{( 2 n + 1 ) q π}{16} ) & ( 21 )\end{matrix}$$

where it follows from (16) that

$$Var [ {z}_{m , n}^{2} ] = \frac{4}{{γ}^{2}} {μ}_{{z}_{m , n}}^{4 - 2 γ} ( a {μ}_{{z}_{m , n}}^{γ} + b ) = 4 {μ}_{{z}_{m , n}}^{2} {α}_{p , q} {β}_{p , q} \qquad ( 22 )$$

Consequently, from (19)-(22) we obtain:

(S_{p,q}+1)α_{p,q}β_{p,q}+3β_{p,q}=4S_{p,q}μ_{z}_{_{m,n}}² (23)

For the sake of simplification, by solving equations (18) and (23) and again using the Taylor series, we obtain a nearly linear relation

β_{p,q}⁻¹=c_{p,q}α_{p,q}+d_{p,q} (24)

where the parameters (c_{p, q}, d_{p, q}) depend both on the frequency (p,q) and on the parameters (a, b) of the photographic camera. Consequently, the parameters (c_{p, q}, d_{p, q}) can be used as fingerprint for identifying the model of the photographic camera.

5.B—Estimation of the Print of the Photographic Camera

It is important to recall that the JPEG compression involves basic steps, namely: the DCT operation, the uniform quantization of the DCT coefficients with a quantization matrix and an entropy coding of the quantized values. Consequently, it seems that the fingerprints of the photographic camera (c_{p, q}, d_{p, q}) which is given by the mathematical analysis hereinabove could work with the quantized original DCT coefficients extracted from the JPEG file. However, because of the effect of the quantization, the information which is not visually significant is ignored. The high frequency contains most of the zeros. Thus there are insufficient statistics to estimate the parameters (c_{p, q}, d_{p, q}). Furthermore, the parameters (c_{p,q}, d_{p, q}) estimated at low frequency may be contaminated because their DCT coefficients are strongly influenced by the content of the image.

Let Z be a color image with three components Z={Z^{c}} where c∈{R, G, B} designates the red, green and blue channel index. In order to attenuate the impact of the content of the image, we propose to delete the content of the image from the image Z given in the spatial domain by using a denoising filter D on each color channel to obtain a residual image W^{c}

W^{c}=Z^{c}− [symbol] (Z^{c}) (25)

The residual image with 3 components {W^{c}} is converted into a monochrome image as

W̅=0.2989W^{R}+0.587W^{G}+0.114W^{B} (26)

The residual image W̅ is thereafter transformed into the DCT domain

I^{W}=DCT(W̅) (27)

where I^{W} is the image of the DCT coefficients of the residual image W̅.

For the sake of clarity, the image I^{W} is arranged in 64 vectors of DCT coefficients following the “zig-zag” order used in the JPEG compression standard. Let I^{W}_{K}=(I_{k,1}^{W}, . . . , I^{W}_{k,N}) T, k∈{1, . . . , 64} be the vector of length N representing the k-th DCT coefficient where I^{W}_{k, i}, 1≤i≤N designates the value of the k-th DCT coefficient of block i and U^{T} designates the transpose of the matrix U. In an analogous manner, the parameters characterizing the distribution of I^{W}ₖ are designated (αₖ, βₖ) and the fingerprints of the photographic camera are also denoted (cₖ, dₖ).

The mathematical analysis performed hereinabove is based on the strong hypothesis that the pixels are distributed in an identical manner inside a small 8×8 block. This hypothesis may not be realistic because of the presence of edges or of details in a natural image. Consequently, to ensure the mathematical framework in an approximate manner, we work solely on the homogeneous 8×8 blocks and we perform the estimation of the parameters on the selected data. Before the selection of a block, the saturated blocks must be excluded because they falsify the mathematical framework hereinabove. A pixel is designated as saturated if its gray level value lies in the zone corresponding to the lower or upper 10% of the dynamic range (typically the dynamic range is [0255] for an 8-bit image, the saturated zones are therefore [0,25] and [220 255]). A block is designated as saturated if there exists at least one saturated pixel in the block. The selection of the blocks is carried out by a simple non-adaptive method based on the standard deviation of the block. The idea is that in a homogeneous block with no edge or in detail, the standard deviation of the block ought to be low. The standard deviation of the block is estimated by a robust estimator: the median of the mean absolute deviation (MAD) value. Consequently, a block i is selected if the following two conditions are fulfilled

$$\{ \begin{matrix}{s}_{i} = 1.4826 \cdot {median}_{k} \vert {I}_{k , i} - {median}_{k} ( {I}_{k , i} ) \vert \leq {τ}_{1} \\ {s}_{i}^{w} = 1.4826 \cdot {median}_{k} \vert {I}_{k , i}^{w} - {median}_{k} ( {I}_{k , i}^{w} ) \vert \leq {τ}_{2}\end{matrix} \qquad ( 28 )$$

where k∈{2, . . . , 64} and I_{k,i} designates the k-th DCT coefficient in the block i of the gray level image Z̅ when using the same transformation as in (26). Here, instead of calculating the median of the mean absolute deviation (MAD) value of each block in the spatial domain, we calculate the median of the mean absolute deviation (MAD) value in the DCT domain so as to profit from the decorrelation and energy compacting properties of the DCT and thus obtain a better estimation of the standard deviation. The DC coefficients are excluded from the calculation. The thresholds [symbol] ₁ and [symbol] ₂ are fixed at [symbol] ₁=1.5 and [symbol] ₂=0.8. It should be noted that the first condition is to eliminate blocks with strong edges and the second is to delete the blocks where a disturbance may exist because of the denoising filter.

In practice, the print of the photographic camera (cₖ, dₖ) must be estimated on the basis of a single image. Consequently, several pairs of (αₖ,βₖ) based on a single image are necessary. Let N̅ be the number of blocks selected, for each frequency, we randomly extract N [symbol] samples with N [symbol] ≤N̅ of I^{W}_{k i}, i∈{1, . . . , N [symbol] } and [symbol] ∈{1, . . . , L}, on the basis of N samples, the estimation of the maximum likelihood ML of the parameters (αₖ,βₖ) is performed. The parameters (cₖ, dₖ) are estimated by considering L pairs of (̂α_{k, l}, ̂β_{k, l}), [symbol] {1, . . . , L}, and by applying the ordinary least squares (OLS) estimations cf. [36]. From relation (24) we obtain:

$$( \begin{matrix}{\hat{c}}_{k} \\ {\hat{d}}_{k}\end{matrix} ) = {( {H}_{k}^{T} {H}_{k} )}^{- 1} {H}_{k}^{T} {V}_{k} \\ {H}_{k} = ( \begin{matrix}{\hat{α}}_{k , 1} & 1 \\ ⋮ & ⋮ \\ {\hat{α}}_{k , L} & 1\end{matrix} ) and {V}_{k} = ( \begin{matrix}{\hat{β}}_{k , 1}^{- 1} \\ ⋮ \\ {\hat{β}}_{k , L}^{- 1}\end{matrix} ) \qquad ( 29 )$$

The OLS estimations (̂cₖ, ̂dₖ) are not biased and are asymptotically equivalent to estimations of the maximum likelihood ML since the ML estimations (α_{k, l}, β_{k, l}) follow the asymptotic Gaussian distribution cf. [37]. Consequently, the estimations (ĉₖ, ̂dₖ) also follow the distribution. In order to ensure that there are sufficient statistics for the estimation, we use L=200 and N [symbol] =4096 (i.e. about 10% of N̅).

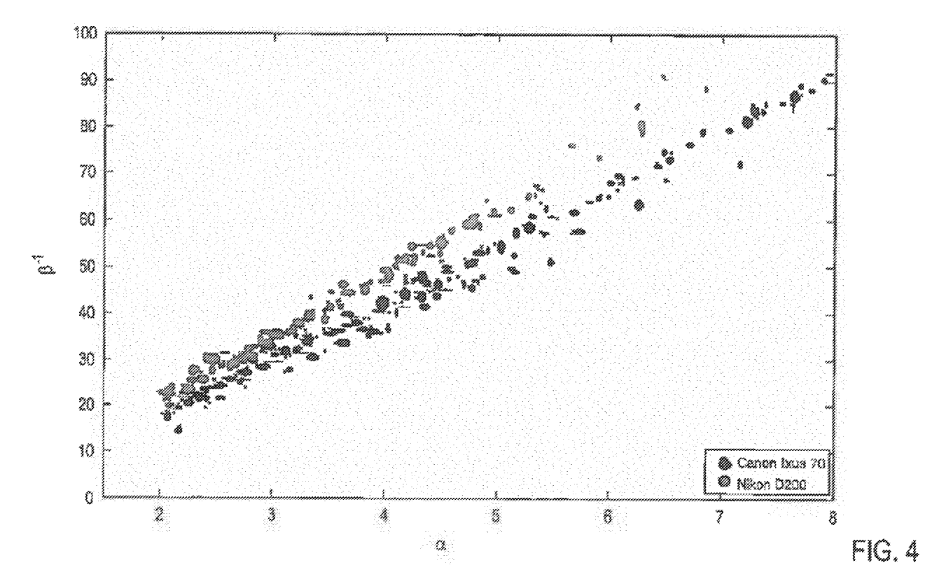

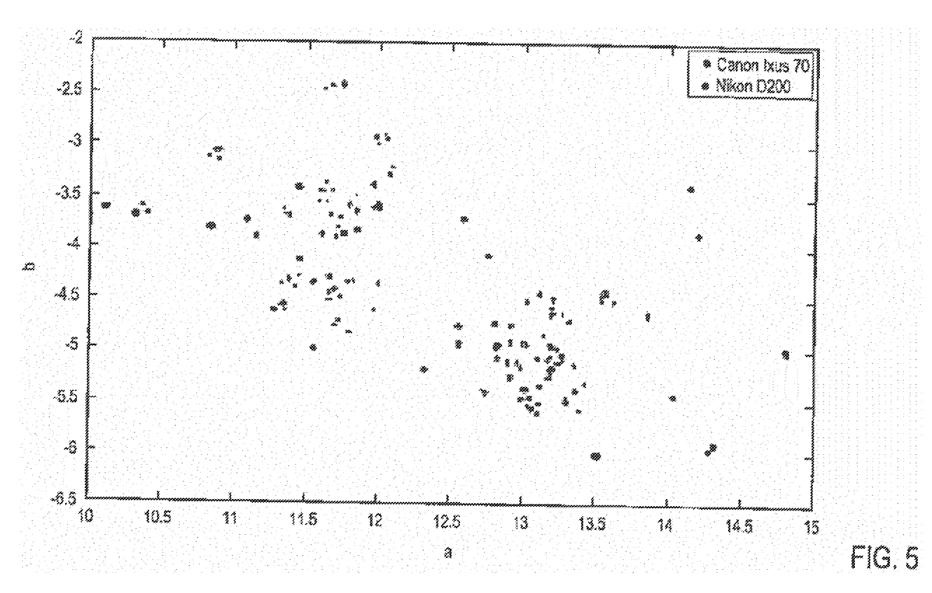

Even if the content of the image is deleted, the low-frequency DCT coefficients of I^{W}ₖ may still be slightly affected. Consequently, it is more relevant to use the high-frequency DCT coefficients of I^{W}ₖ. An example is given in FIG. 4 to illustrate the linear relation between αₖ and βₖ⁻¹. Furthermore, FIG. 5 shows a cloud of points of the parameters (ĉ, ̂d) estimated on the basis of each image by following the above procedure. The images used for FIG. 4 and FIG. 5 cover various scenes and various settings of the photographic camera. The parameters (c, d) are invariant and robust for the processing of the non-linear algorithms. Furthermore, because the parameters (c, d) are related to parameters (a, b) which were proposed for the identification of the model of the photographic camera in [25] and [35], they are also discriminative for various models of the photographic camera and they can also be utilized for identifying the model of the photographic camera.

### 6—FORMULATION OF THE STATISTICAL HYPOTHESES TEST

The present invention is aimed at identifying the models of photographic cameras based on DCT statistics. This part makes it possible to analyze two models of photographic cameras 0 and 1. Each photographic camera model j, j∈{0,1}, is characterized by parameters (c_{k,j}, d_{k,j}) where k designates the frequency with k∈{2, . . . , 64}. In a binary hypothesis test, the inspected image Z is either acquired by a photographic camera model 0, or by a photographic camera model 1. The test objective is to decide between two hypotheses defined by:

$$\{ \begin{matrix}{ℋ}_{0} = \{ {I}_{k , i}^{w} \sim {P}_{{α}_{k} , {β}_{k , 0}} , {β}_{k , 0}^{- 1} = {c}_{k , 0} {α}_{k} + {d}_{k , 0} \} \\ {ℋ}_{1} = \{ {I}_{k , i}^{w} \sim {P}_{{α}_{k} , {β}_{k , 1}} , {β}_{k , 1}^{- 1} = {c}_{k , 1} {α}_{k} + {d}_{k , 1} \}\end{matrix} \qquad ( 30 )$$

where [symbol] _{αk, βk,j}. represents the statistical distribution of the DCT coefficients of I^{W}_{k,i} under hypothesis [symbol] of the parameters (αₖ, β_{k,j}). As explained previously, the emphasis is placed on the prescribed guarantee of a probability of false alarm. Consequently, we define

$${𝒦}_{{α}_{0}} = \{ δ \text{:} {sup}_{θ} {ℙ}_{{ℋ}_{0}} [ δ ( Z ) = {ℋ}_{1} ] \leq {α}_{0} \}$$

to be the class of tests whose probability of false alarm is less than the bound prescribed by α0. Here, [symbol] ( [symbol] ) represents the probability of event [symbol] under the hypothesis [symbol] with j∈{0,1}, and the supremum over θ should be understood as any value for the parameters of the model. Among all the tests of class Kα₀, the aim is to find a test δ which maximizes the power function, defined by the probability of correct detection:

β_{δ}= [symbol] [δ(Z)= [symbol] ₁]

The problem defined in (30) evinces three fundamental difficulties in identifying the model of the photographic camera. Firstly, even if all the model parameters (αₖ, c_{k, j}, d_{k, j}) are known, the most powerful test, namely the LRT, has never been studied for this problem. The second difficulty relates to the unknown nuisance parameters αₖ in practice. A possible approach for coping with unknown nuisance parameters consists in eliminating them by using the invariance principle cf. [38]. This approach was discussed in references [39], [40] and has achieved good performance in certain applications cf. [41]. However, this approach cannot be applied here since the tested hypotheses do not possess the “symmetry” properties required for the application of the invariance principle in statistics. Another approach is to design a GLRT test by replacing the unknown parameters with estimations of the maximum likelihood ML cf. [42]. Finally, the two hypotheses [symbol] and [symbol] are composite since the parameters of the photographic camera (c_{k, j}, d_{k, j}) are unknown.

For the sake of clarity, we assume that the parameters of the photographic camera (c_{k, 0}, d_{k, 0}) are known and we solve only the problem in which the alternative hypothesis [symbol] is composite, stated otherwise, the parameters of the photographic camera (c_{k,1}; d_{k,1}) are not known. It should be noted that a test which maximizes the detection power whatever it be (c_{k,1}; d_{k,1}) could exist. Our main objective is to study the LRT test and to design the GLRT test to address the second and third difficulties.

Furthermore, it should be stressed that the GLRT test processed with unknown nuisance parameters αₖ, when the parameters of the photographic camera are known, may be interpreted as a closed hypothesis test where a given image is either acquired by the photographic camera model 0, or by the photographic camera model 1. Whereas, the GLRT test processed with the parameters of the unknown photographic camera (c_{k,1}; d_{k,1}) becomes an open hypothesis test in which a given image is acquired by a photographic camera model 0 or not. Indeed, the given image may be acquired by an unknown photographic camera model. Consequently, the two proposed tests may be applied, depending on the requirement of the context.

6.A—Test of the Likelihood Ratio for Two Simple Hypotheses

When all the parameters of the model are known, by virtue of the Neyman-Pearson lemma [31, theorem 3.2.1], the most powerful test, δ which solves the problem (30) is the LRT test proposed by the following decision rule:

$$δ ( Z ) = \{ \begin{matrix}{ℋ}_{0} & if Λ ( Z ) = {\sum }_{i = 1}^{\overline{N}} Λ ( {I}_{k , i}^{w} ) < τ \\ {ℋ}_{1} & if Λ ( Z ) = {\sum }_{i = 1}^{\overline{N}} Λ ( {I}_{k , i}^{w} ) \geq τ\end{matrix} \qquad ( 31 )$$

the decision threshold [symbol] is the solution of the following equation:

[symbol]

[Λ(Z)≥τ]=α₀ (32)

to ensure that the LRT test is in the class Kα₀, by using the approximation, defined in (8), of the DCT coefficient model, the likelihood ratio (LR) of an observation I^{W}_{k,i} is defined by

$$\begin{matrix}Λ ( {I}_{k , i}^{w} ) = log \frac{{P}_{{α}_{k} , {β}_{k , 1}} ( {I}_{k , i}^{w} )}{{P}_{{α}_{k} , {β}_{k , 0}} ( {I}_{k , i}^{w} )} \\ = \frac{{α}_{k}}{2} log \frac{{β}_{k , 1}^{- 1}}{{β}_{k , 0}^{- 1}} - \sqrt{2} \vert {I}_{k , i}^{w} \vert ( \sqrt{{β}_{k , 1}^{- 1}} - \sqrt{{β}_{k , 0}^{- 1}} )\end{matrix} \qquad ( 33 )$$

The statistical distribution of the likelihood ratio, LR denoted ∧(Z), under each hypothesis [symbol] is given by

$$Λ ( Z ) {\to }^{D} 𝒩 ( {m}_{j} , {v}_{j} ) \qquad ( 34 )$$

where the notation [symbol] designates convergence toward the distribution and (mⱼ, vⱼ) designate respectively the mean and the variance of the LR A (Z) defined further on in (66) and (67). As a natural RAW image is heterogeneous, it is proposed to normalize the LR ∧ (Z) so as to fix the decision threshold independently of the content of the image. The normalized LR is defined by

$${Λ}^{*} ( Z ) = \frac{Λ ( Z ) - {m}_{0}}{\sqrt{{v}_{0}}} \qquad ( 35 )$$

Consequently, the corresponding test δ* is rewritten as follows:

$${δ}^{*} ( Z ) = \{ \begin{matrix}{ℋ}_{0} & if {Λ}^{*} ( Z ) < {τ}^{*} \\ {ℋ}_{1} & if {Λ}^{*} ( Z ) \geq {τ}^{*}\end{matrix} \qquad ( 36 )$$

Normalization of the LR of ∧ (Z) allows the test δ* to be applicable to any natural RAW image since the normalized LR ∧* (Z) follows the standard Gaussian distribution under the hypothesis [symbol] . The decision threshold [symbol] * and the power function β_{δ}* are obtained through the following theorem:

Theorem 1:

Assuming that all the parameters of the model (αₖ, c_{k,j}, d_{k,j}) are exactly known, the decision threshold and the power function β_{δ}* of the test δ* is given by

$$\begin{matrix}{τ}^{*} = {Φ}^{- 1} ( 1 - {α}_{0} ) & ( 37 ) \\ {β}_{{δ}^{*}} = 1 - Φ ( \frac{{m}_{0} - {m}_{1} + {τ}^{*} \sqrt{{v}_{0}}}{\sqrt{{v}_{1}}} ) & ( 38 )\end{matrix}$$

where ϕ (⋅) and ϕ⁻¹ (⋅) designate respectively the distribution function of the standard Gaussian distribution and its reciprocal function.

This decision threshold guarantees that the false-alarm probability will be equal to α₀, that is to say to decide that the photograph does not originate from the photographic camera 0 although this is actually the case.

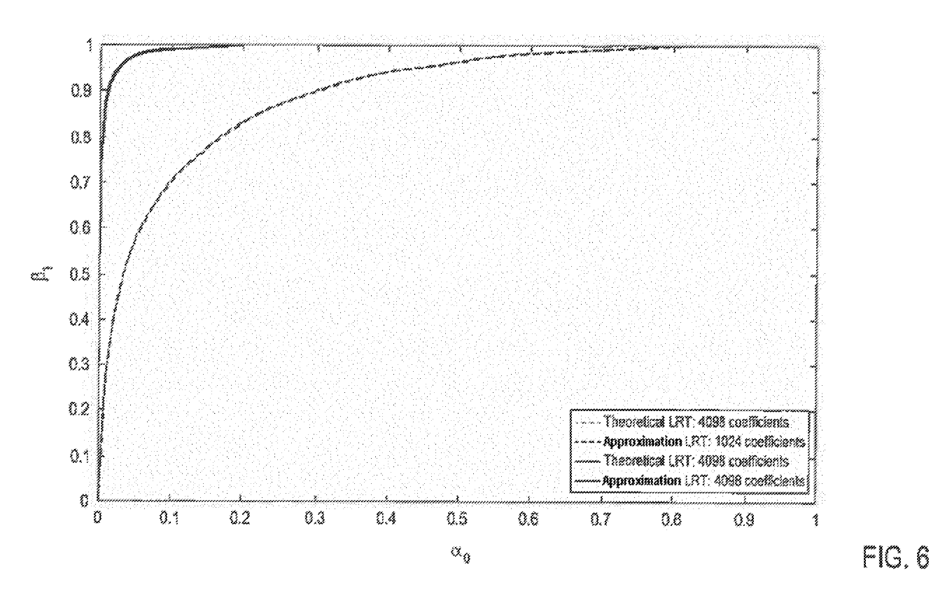

As we propose to design the LRT test by using the approximation function for the DCT coefficient model defined in (8), it is desirable to evaluate the loss of power between the theoretical LRT test and the approximate LRT. In the theoretical LRT test, we use the exact DCT coefficient model, defined in (7), and the mean as well as the variance of the LR are calculated numerically by calculating integrals. The power function of the two LRT tests is represented in FIG. 6 for the data simulated with parameters α=3, c₀=11.5, d₀=−4, c₁=13, d₁=−5.5. These parameters correspond respectively to parameters at the frequency 64 of Canon Ixus 70 and of the Nikon D200 cameras of the Dresden image database cf. [33]. (see FIG. 5). They are used to generate two vectors of coefficients 2¹⁰ and 2¹². The simulation is carried out with 5000 repetitions.

FIG. 6 clearly shows that the power loss between the theoretical LRT test and the approximate LRT is negligible. The detection power β_{δ}* serves as upper bound of a statistical test for the problem of identifying the photographic camera. The test δ* makes it possible to justify a prescribed false alarm rate and also maximizes the probability of detection. As its statistical performance is analytically established, it can provide a forecastable analytical result for any probability of false alarm α₀.

In fact, the LRT test is aimed at taking a decision by using the ratio between the maximum likelihood function of a given image under the alternative hypothesis [symbol] ₁ characterized by the parameters of the photographic camera (c_{k, 1}, d_{k, 1}) and the maximum likelihood function under the null hypothesis [symbol] characterized by the parameters of the photographic camera (c_{k, 0}, d_{k, 0}). If this ratio is below a threshold, the null hypothesis [symbol] is accepted. Conversely, the alternative hypothesis [symbol] is accepted. Consequently, the smaller the distance between the two points (c_{k, 0}, d_{k, 0}) and (c_{k, 1}, d_{k, 1}) the more difficult the identification of the photographic camera.

6.B—Test of the Generalized Likelihood Ratio

In this part, two GLRT tests are designed to deal with unknown parameters. It is proposed to replace the unknown parameters with their maximum likelihood ML estimations defined in (33). Assuming that the parameters of the photographic camera (c_{k, 0}, d_{k, 0}) and (c_{k, 1}, d_{k, 1}) are known, the first GLRT test is designed as follows

$${\hat{δ}}_{1} ( Z ) = \{ \begin{matrix}{ℋ}_{0} & if {\hat{Λ}}_{1} ( Z ) = {\sum }_{i = 1}^{\overline{N}} {\hat{Λ}}_{1} ( {I}_{k , i}^{w} ) < {\hat{τ}}_{1} \\ {ℋ}_{1} & if {\hat{Λ}}_{1} ( Z ) = {\sum }_{i = 1}^{\overline{N}} {\hat{Λ}}_{1} ( {I}_{k , i}^{w} ) \geq {\hat{τ}}_{1}\end{matrix} \qquad ( 39 )$$

where, again to ensure ̂δ₁ is in the class Kα0, ̂ [symbol] ₁ is the solution of the equation

[symbol]

[\hat{Λ}₁(Z)≥\hat{τ}₁]=α₀ (40)

and the generalized likelihood ratio (GLR) of ̂∧₁ (I^{W}_{k,i}) is given by

$${\hat{Λ}}_{1} ( {I}_{k , i}^{w} ) = \frac{{\hat{α}}_{k}}{2} log \frac{{\hat{β}}_{k , 1}^{- 1}}{{\hat{β}}_{k , 0}^{- 1}} - \sqrt{2} \vert {I}_{k , i}^{w} \vert ( \sqrt{{\hat{β}}_{k , 1}^{- 1}} - \sqrt{{\hat{β}}_{k , 0}^{- 1}} )$$

Here, the maximum likelihood ML estimation of ̂αₖ is given by the previously proposed procedure and ̂β⁻¹_{k,j}=c_{k, j}̂αₖ+d_{k, j}, j∈{0, 1}. The ML estimation of ̂αₖ converges asymptotically to its true value: ̂αₖ [symbol] αₖ. Consequently, in accordance with the Slutsky's theorem [38, theorem 11.2.11], we obtain the asymptotic statistical distribution of the GLR of ̂∧1 (Z) under each hypothesis

[symbol]

$${\hat{Λ}}_{1} ( Z ) {\to }^{D} 𝒩 ( {m}_{j} , {v}_{j} ) \qquad ( 42 )$$

As in the case of the LRT test, it is proposed to normalize the GLR ̂∧1 (Z). However, the expectation m₀ and the variance v₀ are not defined since the parameter αₖ is unknown in practice. We replace αₖ with ̂αₖ defined in (66) and (67) to obtain the estimations of m₀ and of v₀ designating respectively ̂m₀⁽¹⁾ and ̂v₀⁽¹⁾. Consequently, the normalized GLR ̂∧*₁ (Z) is defined by:

$${\hat{Λ}}_{1}^{*} ( Z ) = \frac{{\hat{Λ}}_{1} ( Z ) - {\hat{m}}_{0}^{( 1 )}}{\sqrt{{\hat{v}}_{0}^{( 1 )}}} \qquad ( 43 )$$

and the corresponding ̂δ*₁ is rewritten as follows

$${\hat{δ}}_{1}^{*} ( Z ) = \{ \begin{matrix}{ℋ}_{0} & if {\hat{Λ}}_{1}^{*} ( Z ) < {\hat{τ}}_{1}^{*} \\ {ℋ}_{1} & if {\hat{Λ}}_{1}^{*} ( Z ) \geq {\hat{τ}}_{1}^{*}\end{matrix} \qquad ( 44 )$$

Again using the Slutsky's theorem [38, theorem 11.2.11], we obtain the decision threshold and the power function of the test ̂δ*₁.

Theorem 2.

When the parameters of the photographic camera (c_{k, 0}, d_{k, 0}) and (c_{k, 1}, d_{k, 1}) are known, the decision threshold and the power function of the test ̂δ*₁ are given by

$$\begin{matrix}{\hat{τ}}_{1}^{*} = {Φ}^{- 1} ( 1 - {α}_{0} ) and & ( 45 ) \\ {β}_{{\hat{δ}}_{1}^{*}} = 1 - Φ ( \frac{{m}_{0} - {m}_{1} + {\hat{τ}}_{1}^{*} \sqrt{{v}_{0}}}{\sqrt{{v}_{1}}} ) & ( 46 )\end{matrix}$$

When the parameters of the photographic camera (c_{k, 1}, d_{k, 1}) are not known, we can also design the GLRT test according to the procedure hereinabove. The unknown parameters (c_{k,1}, d_{k,1}) are replaced with the OLS estimations of (̂c_{k, 1}, ̂d_{k,1}) defined in (33)

$${\hat{Λ}}_{2} ( {I}_{k , i}^{w} ) = \frac{{\hat{α}}_{k}}{2} log \frac{{\hat{β}}_{k , 1}^{- 1}}{{\hat{β}}_{k , 0}^{- 1}} - \sqrt{2} \vert {I}_{k , i}^{w} \vert ( \sqrt{{\hat{β}}_{k , 1}^{- 1}} - \sqrt{{\hat{β}}_{k , 0}^{- 1}} ) \qquad ( 47 )$$

where ̂β⁻¹_{k,0}=̂c_{k, 0}̂αₖ+d_{k, 0} and ̂β⁻¹_{k,j}=^{̂}c_{k, 1}̂αₖ+̂d_{k, 1}.

As the OLS estimations of (̂c_{k,1}, ̂d_{k,1}) are compliant, the GLR ̂∧2 (Z)=Σ^{N̅}ᵢ₌1̂∧2 (I^{W}_{k,i}) also converges toward the Gaussian distribution with the mean mⱼ and the variance vⱼ under each hypothesis [symbol] ⱼ. Likewise, the normalized GLR ̂∧2 (Z) is defined by

$${\hat{Λ}}_{2}^{*} ( Z ) = \frac{{\hat{Λ}}_{2} ( Z ) - {\hat{m}}_{0}^{( 2 )}}{\sqrt{{\hat{v}}_{0}^{( 2 )}}} \qquad ( 48 )$$

where ̂m₀⁽²⁾ and ̂v₀⁽²⁾ are the estimations of the expectation m₀ and of the variance v₀ on replacing αₖ with ̂αₖ and (c_{k,1}, d_{k,1}) with (̂c_{k,1}, ̂d_{k,1}). The corresponding test ̂δ*₂ is rewritten as follows

$${\hat{δ}}_{2}^{*} ( Z ) = \{ \begin{matrix}{ℋ}_{0} & if {\hat{Λ}}_{2}^{*} ( Z ) < {\hat{τ}}_{2}^{*} \\ {ℋ}_{1} & if {\hat{Λ}}_{2}^{*} ( Z ) \geq {\hat{τ}}_{2}^{*}\end{matrix} \qquad ( 49 )$$

In accordance with Slutsky's theorem, the decision threshold and the power function of the test ̂δ*₂ are given by the following theorem:

Theorem 3.

When the parameters of the photographic camera (c_{k,0}, d_{k,0}) are known and the parameters (c_{k,1}, d_{k,1}) are not known, the decision threshold and the power function of the test δ*₂ are given by:

$$\begin{matrix}{\hat{τ}}_{2}^{*} = {Φ}^{- 1} ( 1 - {α}_{0} ) and & ( 50 ) \\ {β}_{{\hat{δ}}_{2}^{*}} = 1 - Φ ( \frac{{m}_{0} - {m}_{1} + {\hat{τ}}_{2}^{*} \sqrt{{v}_{0}}}{\sqrt{{v}_{1}}} ) & ( 51 )\end{matrix}$$

The two proposed GLRT tests can be applied in the practical context. The first GLRT test ̂δ*₁ is aimed at detecting any given image acquired by the photographic camera model 0 or the photographic camera model 1 while the GLRT test ̂δ*₂ is aimed at verifying whether the given image is acquired by the model of the photographic camera 0.

This decision threshold guarantees that the false-alarm probability will be equal to α₀, that is to say to decide that the photograph does not originate from the photographic camera 0 whereas this is actually the case.

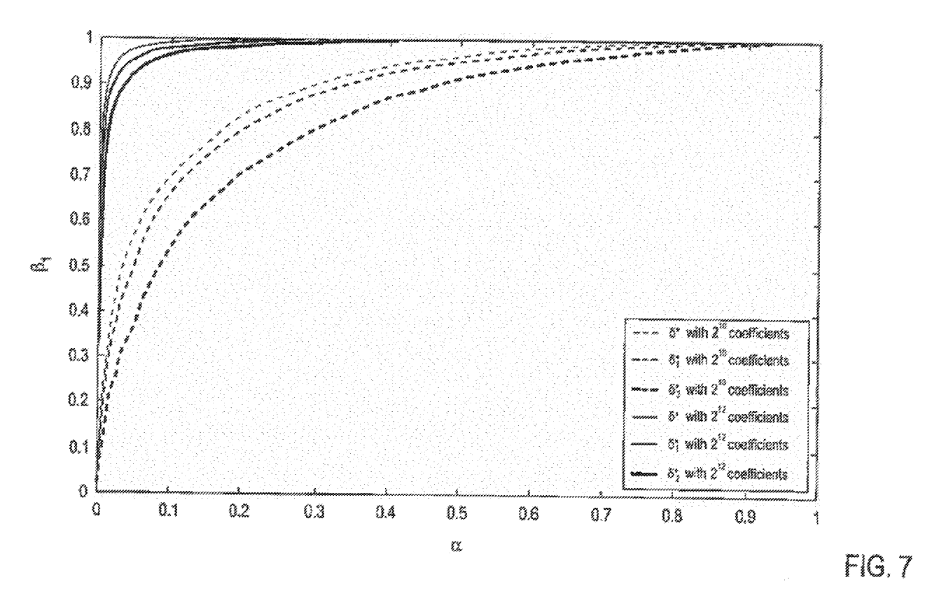

FIG. 7 represents the power function of two GLRT tests ̂δ*₁ and ̂δ*₂ compared with the LRT test δ* for the coefficients 2¹⁰ and 2¹². The power loss is obviously revealed because of the error in estimating the parameters of the model. Moreover, it may be noted that the power loss decreases as the number of coefficients increases. For coefficients 2¹⁴ used, all the tests are perfect, β_{δ*}=β_{̂δ*1}=β_{̂δ*1}=1, that is to say that there is no detection error on 5000 images simulated on the basis of the model of the photographic camera 0 and on 5000 images simulated on the basis of the model of the photographic camera 1.

The proposed procedure can be extended to the images arising from a video stream. A video stream is composed of a succession of images which file past at a fixed tempo. Video compression is a data compression procedure which consists in reducing the quantity of data, while minimizing the impact on the visual quality of the video. The benefit of video compression is to reduce the costs of storing and transmitting video files. Video sequences contain very great statistical redundancy, both in the temporal domain and in the spatial domain. The fundamental statistical property on which compression techniques are based is correlation between pixels. This correlation is both spatial, the adjacent pixels of a current image are similar, and temporal, the pixels of the past and future images are also very close to the current pixel. Video compression algorithms of MPEG type use the DCT (discrete cosine transform) transformation on blocks of 8×8 pixels, to efficiently analyze the spatial correlations between neighboring pixels of the same image. Thus, in the method according to the invention the photograph may be an image arising from a video stream and compressed according to the MPEG standard.

It is possible to envisage another case of using the system to identify a photographic camera model with a view to determining whether a zone of the image has not been falsified, by copying/pasting from another photograph or by deletion of an element.

Finally, it is possible to envisage another case of using the system to identify a photographic camera with a view to determining, in a supervised manner, if a zone of the image has not been falsified (by copying/pasting from another photograph or by deletion of an element). Here, “supervised” is intended to mean the fact that the user wishes to make sure of the integrity of a previously defined zone. The principle is then to apply the identification procedure to the two “sub-images” arising respectively from the zone targeted by the user and from its complement (the remainder of the image). If the inspected element originates from another photograph and has been added by copying/pasting, the noise properties will be different, something that the proposed system will be capable of identifying (by assuming that the photographs were not taken under the same acquisition conditions and with the same photographic camera model, which seems reasonable).

The proposed procedure for identifying the photographic camera model addresses the two weaknesses of the procedures briefly presented in the prior art: 1) their performance is not established and, 2) these procedures can be foiled by the calibration of the photographic camera. The proposed procedure relying on the noise properties inherent in the acquisition of compressed photographs, it is applicable whatever the post-acquisition processings applied by a user (in particular with a view to improving visual quality). Furthermore, the parametric modeling of the statistical distribution of the value of the pixels in the frequency domain makes it possible to analytically provide the performance of the proposed test. This advantage makes it possible in particular to ensure compliance with a prescribed constraint on the probability of error.

The main fields of application of the invention are on the one hand, the search for proof on the basis of a “compromising” image and, on the other hand, the guarantee that a photograph was acquired by a given camera.

The proposed procedure can be extended to checking the integrity of a photograph. The aim is then to guarantee that a photograph has not been modified/falsified since its acquisition. This makes it possible for example to detect photographs comprising elements originating from a different photographic camera, i.e. imported after acquisition, or else to ensure the integrity of a scanned or photographed document (a legal document for example).

The method of the invention will be able to be developed in specialized software from software manufacturers, in the search for proof on the basis of digital media. The method according to the invention can be used in court with a view to providing a decision aid tool.

### 7—NUMERICAL EXPERIMENTS

7.A—Results on a Large Database

### Annex A

### The Laplace Approximation of a DCT Coefficient Model

We shall briefly describe the Laplace approximation [43]. The Laplace procedure is aimed at providing an approximation of the integrals of the form ∫exp (−g (t)) dt when the function g (t) attains the global minimum at t*. Let us consider the integral

I=∫e^{-g(t)}dt (52)

The Taylor expansion of the function g (t) at t* gives:

$$g ( t ) = g ( {t}^{*} ) + {g}^{′} ( {t}^{*} ) ( t - {t}^{*} ) + \frac{{g}^{″} ( {t}^{*} )}{2} {( t - {t}^{*} )}^{2} + o ( {( t - {t}^{*} )}^{2} ) \qquad ( 53 )$$

where g′ (t) and g″(t) represent respectively the first and second derivatives of the function g (t). Given that the function g (t) attains a minimum at t *, g′ (t *)=0. Consequently, the integral I can be approximated as

$$ℐ \approx {e}^{- g ( {t}^{*} )} \int {e}^{- \frac{{g}^{″} ( {t}^{*} )}{2} {( t - {t}^{*} )}^{2}} dt \qquad ( 54 )$$

This integral takes the form of the Gaussian integral. We obtain:

$$ℐ \approx \sqrt{\frac{2 π}{\vert {g}^{″} ( {t}^{*} ) \vert}} {e}^{- g ( {t}^{*} )} \qquad ( 55 )$$

A generalization was made in [32] with an arbitrary function h(t)

$$ℐ = \int h ( t ) {e}^{- g ( t )} dt \approx \sqrt{\frac{2 π}{\vert {g}^{″} ( {t}^{*} ) \vert}} h ( {t}^{*} ) {e}^{- g ( {t}^{*} )} \qquad ( 56 )$$

On the basis of relation (6), the DCT coefficient model of f_{I} (x) is rewritten as follows

$$\begin{matrix}{f}_{I} ( x ) = \frac{1}{\sqrt{2 π} {β}^{α} Γ ( α )} {\int }_{0}^{∞} h ( t ) {e}^{- g ( t )} dt where & ( 57 ) \\ g ( t ) = \frac{t}{β} + \frac{{x}^{2}}{2 t} and h ( t ) = {t}^{α - \frac{2}{3}} & ( 58 )\end{matrix}$$

The function g(t) attains the minimum at r=|x|√β/2 and its second derivative is defined by g″ (t)=x²/t³. Consequently, the function f_{I} (x) can be approximated as follows:

$${f}_{I} ( x ) \approx \frac{{\vert x \vert}^{α - 1}}{{( 2 β )}^{\frac{α}{2}} Γ ( α )} {e}^{- \vert x \vert \sqrt{\frac{2}{β}}} \qquad ( 59 )$$

### Annex B

### Statistical Distribution of the Test LR ∧(Z)

Note that on the basis of relation (33) it is necessary to define the first two moments of the variable |I|. Given a known variance σ², the random variable I is the Gaussian variable of zero mean with the variance σ². Thus, the random variable |I| follows the half-normal distribution cf. [44]. Consequently, we obtain

$${𝔼}_{I \vert {σ}^{2}} [ \vert I \vert \vert {σ}^{2} ] = √ \frac{2}{π} σ \qquad ( 60 )$$

On the basis of the law for the total expectation, the mathematical expectation of |I| is given by

$$\begin{matrix}{𝔼}_{I} [ \vert I \vert ] = {𝔼}_{{σ}^{2}} [ {𝔼}_{I \vert {σ}^{2}} [ \vert I \vert \vert {σ}^{2} ] ] \\ = \sqrt{\frac{2}{π}} {𝔼}_{{σ}^{2}} [ σ ] \\ = \sqrt{\frac{2}{π}} {β}^{\frac{1}{2}} \frac{Γ ( α + \frac{1}{2} )}{Γ ( α )}\end{matrix} \qquad ( 61 )$$

Furthermore, the variance of |I| is given by

$$\begin{matrix}{Var}_{I} [ \vert I \vert ] = {𝔼}_{I} [ {\vert I \vert}^{2} ] - {𝔼}_{I}^{2} [ \vert I \vert ] \\ = αβ - \frac{2 β}{π} \frac{{Γ}^{2} ( α + \frac{1}{2} )}{{Γ}^{2} ( α )}\end{matrix} \qquad ( 62 )$$

Consequently, it follows from (33) that the first two moments of the LR A (I^{W}_{k,i}) under each hypothesis [symbol] are given by:

$$\begin{matrix}{𝔼}_{{ℋ}_{j}} [ Λ ( {I}_{k , i}^{w} ) ] = \frac{{α}_{k}}{2} log \frac{{β}_{k , 1}^{- 1}}{{β}_{k , 0}^{- 1}} - \frac{2}{\sqrt{π}} {β}_{k , j}^{\frac{1}{2}} \frac{Γ ( {α}_{k} + \frac{1}{2} )}{Γ ( {α}_{k} )} ( \sqrt{{β}_{k , 1}^{- 1}} - \sqrt{{β}_{k , 0}^{- 1}} ) & ( 63 ) \\ {Var}_{{ℋ}_{j}} [ Λ ( {I}_{k , i}^{w} ) ] = 2 {( \sqrt{{β}_{k , 1}^{- 1}} - \sqrt{{β}_{k , 0}^{- 1}} )}^{2} \times ( {α}_{k} {β}_{k , j} - \frac{2 {β}_{k , j}}{π} \frac{{Γ}^{2} ( {α}_{k} + \frac{1}{2} )}{{Γ}^{2} ( {α}_{k} )} ) & ( 64 )\end{matrix}$$

where [symbol] [⋅] and [symbol] [⋅] designate respectively the expectation and the mathematical variance under the hypothesis [symbol] . Because of a large number of coefficients in a natural image, by virtue of the central limit theorem of Lindeberg (CLT) [38, theorem 11.2.5], the statistical distribution of the LR ∧ (Z) is given by

$$Λ ( Z ) {\to }^{D} 𝒩 ( {m}_{j} , {v}_{j} ) \qquad ( 65 )$$

where the notation [symbol] designates convergence in terms of distribution and

$$\begin{matrix}{m}_{j} = \overline{N} {𝔼}_{{ℋ}_{j}} [ Λ ( {I}_{k , i}^{w} ) ] & ( 66 ) \\ {v}_{j} = \overline{N} {Var}_{{ℋ}_{j}} [ Λ ( {I}_{k , i}^{w} ) ] & ( 67 )\end{matrix}$$

with [symbol] ∧ [(I^{W}_{k,i})] and [symbol] [∧ (I^{W}_{k,i})] defined respectively in (63) and (64).

### REFERENCES

[1] T. V. Lanh, K.-S. Chong, S. Emmanuel, and M. Kankanhalli, “A survey on digital camera image forensic methods,” in Multimedia and Expo, 2007 IEEE International Conference on, 2007, pp. 16-19.
[2] T.-T. Ng, S.-F. Chang, C.-Y. Lin, and Q. Sun, “Passive-blind image forensics,” in Multimedia Security Technologies for Digital Rights, 2006.
[3] H. Farid, “A survey of image forgery detection,” IEEE Signal Processing
Magazine, vol. 2, no. 26, pp. 16-25, 2009.
[4] R. Ramanath, W. E. Snyder, Y. Yoo, and M. S. Drew, “Color image processing pipeline,” Signal Processing Magazine, IEEE, vol. 22, no. 1, pp. 34-43, January 2005.
[5] J. Nakamura, Image Sensors and Signal Processing for Digital Still Cameras. CRC Press, 2005.
[6] T. H. Thai, R. Cogranne, and F. Retraint, “Statistical Model of Natural Images,” in ICIP 2012, International Conference on Image Processing, September 2012, pp. 2525-2528.
[7] K. S. Choi, E. Y. Lam, and K. Wong, “Source camera identification using footprints from lens aberration,” in Proc. of the SPIE, vol. 6069, February 2006, pp. 172-179.
[8] M. Kharrazi, H. T. Sencar, and N. Memon, “Blind source camera identification,” in Image Processing, 2004. ICIP '04. 2004 International Conference on, vol. 1, October 2004, pp. 709-712.
[9] S. Bayram, H. Sencar, N. Memon, and I. Avcibas, “Source camera identification based on cfa interpolation,” in Image Processing, 2005. ICIP 2005. IEEE International Conference on, vol. 3, September 2005, pp. 69-72.
[10] A. Swaminathan, M. Wu, and K. J. R. Liu, “Nonintrusive component forensics of visual sensors using output images,” Information Forensics and Security, IEEE Transactions on, vol. 2, no. 1, pp. 91-106, 2007.
[11] H. Cao and A. C. Kot, “Accurate detection of demosaicing regularity for digital image forensics,” Information Forensics and Security, IEEE Transactions on, vol. 4, no. 4, pp. 899-910, December 2009.
[12] K. S. Choi, E. Lam, and K. Wong, “Source camera identification by JPEG compression statistics for image forensics,” in TENCON 2006.
2006 IEEE Region 10 Conference, November 2006, pp. 1-4. [13] G. Xu, S. Gao, Y. Q. Shi, R. Hu, and W. Su, “Camera model identification using markovian transition probability matrix,” in Proc. 9th Int. Workshop Digital Watermarking, vol. 5703. Springer, August 2009, pp. 294-307.
[14] Z. Deng, A. Gijsenij, and J. Zhang, “Source camera identification using auto-white balance approximation,” in Computer Vision (ICCV), 2011 IEEE International Conference on, November 2011, pp. 57-64.
[15] C. Scott, “Performance measures for Neyman-Pearson classification,” Information Theory, IEEE Transactions on, vol. 53, no. 8, pp. 2852-2863, August 2007.
[16] J. Lukas, J. Fridrich, and M. Goljan, “Digital camera identification from sensor pattern noise,” Information Forensics and Security, IEEE Transactions on, vol. 1, no. 2, pp. 205-214, June 2006.
[17] M. Chen, J. Fridrich, M. Goljan, and J. Lukas, “Determining image origin and integrity using sensor noise,” Information Forensics and Security, IEEE Transactions on, vol. 3, no. 1, pp. 74-90, March 2008.
[18] M. Goljan, J. Fridrich, and T. Filler, “Large scale test of sensor fingerprint camera identification,” in Proc. SPIE, Electronic Imaging, Security and Forensics of Multimedia Contents XI, vol. 7254, January 2009, pp. 18-22.
[19] C.-T. Li, “Source camera identification using enhanced sensor pattern noise,” Information Forensics and Security, IEEE Transactions on, vol. 5, no. 2, pp. 280-287, June 2010.
[20] X. Kang, Y. Li, Z. Qu, and J. Huang, “Enhancing source camera identification performance with a camera reference phase sensor pattern noise,” Information Forensics and Security, IEEE Transactions on, vol. 7, no. 2, pp. 393-402, April 2012.
[21] C.-T. Li and Y. Li, “Color-decoupled photo response non-uniformity for digital image forensics,” Circuits and Systems for Video Technology, IEEE Transactions on, vol. 22, no. 2, pp. 260-271, February 2012.
[22] T. Filler, J. Fridrich, and M. Goljan, “Using sensor pattern noise for camera model identification,” in Image Processing, ICIP 2008. 15th IEEE International Conference on, October 2008, pp. 1296-1299.
[23] K. Kurosawa, K. Kuroki, and N. Saitoh, “CCD fingerprint method identification of a video camera from videotaped images,” in Image Processing, International Conference on, vol. 3, 1999, pp. 537-540.
[24] T. Gloe, M. Kirchner, A. Winkler, and R. Bohme, “Can we trust digital image forensics?” in International Conference on Multimedia, 2007, pp. 78-86.
[25] T. H. Thai, R. Cogranne, and F. Retraint, “Camera Model Identification based on the Heteroscedastic Noise Model,” be revised and resubmitted to Image Processing, IEEE Transactions on, 2012.
[26]-, “Steganalysis of jsteg algorithm based on a novel statistical model of quantized DCT coefficients,” to be published in ICIP, International Conference on Image Processing, September 2013.
[27] E. Y. Lam and J. W. Goodman, “A mathematical analysis of the DCT coefficient distributions for images,” Image Processing, IEEE Transactions on, vol. 9, no. 10, pp. 1661-1666, October 2000.
[28] F. Muller, “Distribution shape of two-dimensional DCT coefficients of natural images,” Electronics Letters, vol. 29, no. 22, pp. 1935-1936, October 1993.
[29] J.-H. Chang, J.-W. Shin, N. S. Kim, and S. K. Mitra, “Image probability distribution based on generalized gamma function,” Signal Processing Letters, IEEE, vol. 12, no. 4, pp. 325-328, April 2005.
[30] M. Blum, “On the central limit theorem for correlated random variables,” Proceedings of the IEEE, vol. 52, no. 3, pp. 308-309, March 1964.
[31] I. M. Ryzhik and I. S. Gradshteyn, Tables of Integrals, Series, and Products. United Kingdom: Elsevier, 2007.
[32] R. Butler and A. Wood, “Laplace approximations for hypergeometric functions with matrix argument,” The Annals of Statistics, vol. 30, no. 4, pp. 1155-1177, 2002.
[33] T. Gloe and R. Bohme, “The ‘dresden image database’ for benchmarking digital image forensics,” Proc. ACM SAC, vol. 2, pp. 1585-1591, 2010.
[34] J. Nelder and R. Mead, “A simplex method for function minimization,” The Computer Journal, vol. 7, pp. 308-313, 1965.
[35] T. H. Thai, R. Cogranne, and F. Retraint, “Camera model identification based on hypothesis testing theory,” in Signal Processing Conference IEEE TRANSACTION ON IMAGE PROCESSING 11 (EUSIPCO), 2012 Proceedings of the 20th European, August 2012, pp. 1747-1751.
[36] C. Rao and H. Toutenburg, Linear models: Least Squares and Alternatives, 2nd ed. Springer, 1999.
[37] L. Le Cam, Asymptotics Methods in Statistical Decision Theory. New York: Series in Statistics, Springer, 1986.
[38] E. L. Lehmann and J. P. Romano, Testing Statistical Hypotheses, 3rd ed. New York: Springer, 2005.
[39] M. Fouladirad and I. Nikiforov, “Optimal statistical fault detection with nuisance parameters,” Automatica, vol. 41, pp. 1157-1171, 2005.
[40] L. Scharf and B. Friedlander, “Matched subspace detectors,” IEEE Trans. Signal Process., vol. 42, no. 8, pp. 2146-2157, 1994.
[41] L. Fillatre, I. Nikiforov, and F. Retraint, “Epsilon-optimal non-bayesian anomaly detection for parametric tomography,” IEEE Trans. Image Process., vol. 17, no. 11, pp. 1985-1999, 2008.
[42] D. Birkes, “Generalized likelihood ratio tests and uniformly most powerful tests,” The American Statistician, vol. 44, no. 2, pp. 163-166, 1990.
[43] L. Tierney and J. B. Kadane, “Accurate approximations for posterior moments and marginal densities,” Journal of the American Statistical Association, vol. 81, no. 393, pp. 82-86, March 1986.
[44] N. L. Johnson, S. Kotz, and N. Balakrishnan, Continuous univariate distributions, 2nd.

1-10. (canceled)

11. A system for identifying a photographic camera model on the basis of images acquired with a known photographic camera model and of a photograph in the form of a compressed image, the photograph having undergone a post-acquisition processing and obeying a linear relation between expectation and mathematical variance of pixels such that: σ²_{ym,n}=a μ_{ym,n}+b where a and b are two parameters characterizing the photographic camera model, μ_{ym,n} and σ²_{ym,n} are respectively, the expectation and the mathematical variance of the pixel y_{m,n} at position (m,n) having undergone the post-acquisition processing, the system comprising:
an image processing device providing an analytical relation between parameters (α, β), of a statistical distribution model of Discrete Cosine Transformation (DCT) coefficients and the parameters (a, b) of the photographic camera in the form:
β_{p,q}⁻¹=c_{p,q}α_{p,q}+d_{p,q}
so that the parameters (c, d) determine fingerprints characterizing a photographic camera model and depend both on frequency (p, q) and on the parameters a and b; and
a device for executing statistical hypothesis tests of the DCT coefficients and a statistical analysis device to determine whether the photograph has been taken by the photographic camera model or by another photographic camera model.

12. The system according to claim 11, wherein the statistical analysis device provides an indication about the identification of the photographic camera model by certifying accuracy of identification with a previously defined precision.

13. A method implemented in the system according to claim 12, comprising:
reading of a compressed image Z to determine matrices representing a value of the pixels,
estimating print parameters: (c_{p,q}, d_{p,q}),
deleting content of the compressed image Z to obtain a residual image,
estimating the DCT coefficients of the residual image,
executing statistical hypothesis tests with to identify a photographic camera.

14. The method according to claim 13, wherein the statistical hypothesis tests are executed as a function of a prescribed constraint on a probability of error.

15. The method according to claim 13, wherein the photograph is a compressed image according to a JPEG compression standard.

16. The method according to claim 13, wherein the photograph is a reference image, or an inter-frame image belonging to a video stream and compressed according to an MPEG compression standard.

17. The method according to claim 13 further comprising detecting in a non-supervised manner falsification of a zone of a photograph.

18. The method according to claim 13 further comprising detecting in a supervised manner falsification of a zone of a photograph.

19. The method according to claim 13 further comprising searching for proofs on a basis of a compromising photograph.

20. The method according to claim 13 further comprising searching for proofs on a basis of digital media.
